(19) United States
(12) Patent Application Publication
(10) Pub. No.: US 2002/0001690 A1
(43) Pub. Date: Jan. 3, 2002

(54) Copy-protected optical disc and method of manufacture thereof

(76) Inventors: Richard H. Selinfreund, Guilford, CT (US); Jeffrey M. Drew, Darien, CT (US)

Correspondence Address: Steven J. Moore, PILLSBURY WINTHROP LLP, 1600 Tysons Boulevard, McLean, VA, 22102, US

(21) Appl. No.: 09/739,090

(22) Filed: Dec. 15, 2000

Related U.S. Application Data
(63) Continuation-in-part of application No. 09/608,886, filed on Jun. 30, 2000.

(51) Int. Cl. B32B 3/02

(52) U.S. Cl. 428/64.4

(57) ABSTRACT

A method for fabricating read-only copy protected optical dics comprising a light-sensitive material at positions capable of altering the data read during copying of the disc but permitting read of the underlying data in the reading of the disc.

### RELATED ART

This application is a continuation-in-part application of U.S. patent application Ser. No. 09/608,886, filed Jun. 30, 2000, from which priority is claimed.

### BACKGROUND OF THE INVENTION

1. Field of the Invention

The present invention generally relates to copy-protected optical information recording media and methods for manufacturing the same. More specifically, the present invention relates to the manufacture of an optically readable digital storage medium that protects the information stored thereon from being copied using conventional CD and DVD laser readers, but permits reading of the information from the digital storage media by the same readers.

2. Background of the Invention

Optical data storage (“optical discs”) discs are media in which data is stored in an optically readable manner. Data on optical discs are encoded by optical changes in one or more layers of the disc. Optical data discs are used to distribute, store and access large volumes of data. Formats of optical discs include read-only formats such as CD-DA (digital audio compact disc), CD-ROM (CD-read-only memory), DVD (digital versatile disc or digital video disc) media, write-once read-many times (WORM) formats such as CD-R (CD-recordable), and DVD-R (DVD-recordable), as well as rewritable formats such as found on magneto-optical (MO) discs, CD-RW (CD-rewriteable), DVD-RAM (DVD-Random Access Media), DVD-RW or DVD+RW (DVD-rewriteable), PD (Phase change Dual disk by Panasonic) and other phase change optical discs. Erasable, or rewritable, optical discs function in a similar manner to magneto-optical (MO) disks and can be rewritten over and over. MO discs are very robust and are geared to business applications, typically in high-capacity disk libraries.

Optical discs have grown tremendously in popularity since their first introduction owing in a great deal to their high capacity for storing data as well as their open standars. For example, a commercially available magnetic floppy diskette is only capable of storing 1.44 Mb of data, whereas an optical CD-ROM of approximately the same size can have a capacity in excess of 600 MB. A DVD has a recording density which is significantly greater than a CD. For example, conventional DVD read-only discs currently have a capacity of from 4.7 GB (DVD-5, 1 side/1 layer) to 17.0 GB (DVD-18, 2 sides/2 layers), write-once DVDs a capacity of 3.95 GB (DVD-R, 1 side/1 layer) to 7.90 GB (DVD-R, 2 sides/1 layer) (newer DVD-Rs can hold up to 4.7 GB per side), and conventional rewritable DVDs of from 2.6 GB (DVD-RAM, 1 side/1 layer) to 10.4 GB (MMVF, 2 sides/1 layer). Optical discs have made great strides in replacing cassette tapes and floppy disks in the music and software industries, and significant in-roads in replacing video cassette tapes in the home video industry.

Data is stored on optical discs by forming optical deformations or marks at discrete locations in one or more layers of the disc. Such deformations or marks effectuate changes in light reflectivity. To read the data on an optical disc, an optical disc player or reader is used. An optical disc player or reader conventionally shines a small spot of laser light, the “readout” spot, through the disc substrate onto the data layer containing such optical deformations or marks as the disc or laser head rotates.

In conventional “read-only” type optical discs (e.g, “CD-ROM”), data is generally stored as a series of “pits” embossed with a plane of “lands”. Microscopic pits formed in the surface of the plastic disc are arranged in tracks, conventionally spaced radially from the center hub in a spiral track originating at the disc center hub and ending toward the disc's outer rim. The pitted side of a disc is coated with a reflectance layer such as a thin layer of aluminum or gold. A lacquer layer is typically coated thereon as a protective layer.

The intensity of the light reflected from a read-only disc's surface by an optical disc player or reader varies according to the presence or absence of pits along the information track. When the readout spot is over the flat part of the track more light is reflected directly from the disc than when the readout spot is over a pit. A photodetector and other electronics inside the optical disc player translate the signal from the transition points between these pits and lands caused by this variation into the Os and Is of the digital code representing the stored information.

A number of types of optical discs are available which permit an end-user to record data on the disc, such optical discs generally are categorized as “writable” or “recordable”, or “re-writable.”

“Writable” or “recordable” optical discs (e.g., “CD-R” discs) permit an end-user to write data permanently to a disc. Writable discs are designed such that laser light in the writer apparatus causes permanent deformations or changes in the optical reflectivity of discrete areas of the data layer(s) of the disc. Numerous writable discs are known, including those that employ a laser deformable layer in their construct upon which optically-readable areas analogous to the pits and lands found in conventional read-only optical discs can be formed (See, e.g., EP-A2-0353391), those that employ a liquid-crystalline material in their data layer(s) such that irradiation with the laser beam causes permanent optical deformations in the data layer (See, e.g., U.S. Pat. No. 6,139,933 which employs such layer between two reflective layers to effect a Fabry-Perot interferometer), and those that utilize a dye that irreversibly changes state when exposed to a high power writing laser diode and maintains such state when read with a low power reading laser (so-called, WORM, write-once-read-many times, discs).

Rewritable optical discs (e.g., “CD-RW”, “DVD-RAM”, “DVD-RW”, “DVD+RW” and “PD” discs) use the laser beam to cause reversible optical deformations or marks in the data layer(s), such that the data layer is capable of being written on, read, erased and rewritten on many times. Several rewritable optical disc systems are known. In one system, an optically-deformable data layer is deformed in discrete areas by the writing laser to form optical changes representative of the data, for example, pits and lands, and erased by uniformly deforming the same optically-deformable data layer, or the portion thereof wherein the data desired to be deleted is found. In another system, a photochromic material layer is used to store the data. In this system, the photochromic material reversibly changes when the material is irradiated by light possessing certain wavelengths. For example, a colorless compound may change its molecular state to a quasi-stable colored state when irradiated by ultraviolet (UV) light, yet be returned to the colorless state upon exposure to visible light. By selectively irradiating the photochromic material layer with the one wavelength to cause an optical change, and then irradiating with the other wavelength to reverse such optical change, one is permitted to write, erase, and re-write data. In rewritable optical discs control information such as address data, rotation control signal, user information etc. is generally previously recorded on the header field in the form of pre-pits.

Hybrid optical discs are also known. For example, “half-and-half” discs are known wherein one portion of the disc has conventional CD-ROM pits and the other portion of the disc has a groove pressed into the disc with a dye layer thereover to form a CD-R portion. A relatively new hybrid disc is the CD-PROM (i.e., CD programmable ROM). The CD-PROM disc combines a read-only CD-ROM format with a recordable CD-R format on one disc, but features only a single continuous groove on the disc with the entire disc coated with a dye layer. The geometry of the continuous groove of the CD-PROM disc is modulated so as to look like ROM pits to an optical reader. It also provides no dye transition issues to overcome in manufacturing.

An optical disc is read by moving a read head generating a radiation beam in a specified path relative to the optical disc. The radiation beam is used to differentiate regions having different optical properties, such different optical properties being used to represent the data, for example, the “on” logical state being represented by a particular region. The detectable differences are converted into electrical signals, which are then converted to a format that can be conveniently manipulated by a signal processing system. For example, by setting a threshold level of reflectance, transitions between pits and lands may be detected at the point where the signal generated from the reflectance crosses a threshold level. Whenever the threshold level is crossed, i.e., a transition between a pit and a land or between a land and a pit is detected, a binary code of 1 is read. At all other intervals, a 0 is detected. Thus, both pits and lands may actually present a series of 0's. It is the transition that represents a 1. In this manner, binary information may be read from the disc.

The vast majority of commercially-available software, video, audio, and entertainment pieces available today are recorded in read-only optical format. One reason for this is that data replication onto read-only optical formats is significantly cheaper than data replication onto writable and rewritable optical formats. Another reason is that read-only formats are less problematical from a reading reliability standpoint. For example, some CD readers/players have trouble reading CD-R media, which has a lower reflectivity, and thus requires a higher-powered reading laser, or one that is better “tuned” to a specific wavelength. Data is conventionally written onto pre-fabricated writeable and rewritable discs individually, one disc at a time, using a laser. Data is conventionally stamped onto read-only discs by a die moulding (injection moulding) process during the manufacture of the read-only disc. Today many more data-containing optical discs can be manufactured by the stamping process than by the laser writing process over a set unit of time, significantly reducing the cost of such stamped read-only optical discs for large quantities of discs.

Optical discs comprising a read-only format are typically manufactured following a number of defined steps:

Data to be encoded on the disc is first pre-mastered (formatted) such that data can be converted into a series of laser bursts by a laser which will be directed onto a glass master platter. The glass master platter is conventionally coated with a photoresist such that when the laser beam from the LBR (laser beam recorder) hits the glass master a portion of the photoresist coat is “burnt” or exposed. After being exposed to the laser beam, it is cured and the photoresist in the unexposed area rinsed off. The resulting glass master is electroplated with a metal, typically Ag or Ni. The electroformed stamper disc thus formed has physical features representing the data. When large numbers of discs are to be manufactured, the electroformed stamper disc is conventionally called a “father disc”. The father disc is typically used to make a mirror image “mother disc,” which is used to make a plurality of “children discs” often referred to as “stampers” in the art. Stampers are used to make production quantities of replica discs, each containing the data and tracking information which was recorded on the glass master. If only a few discs are to be replicated (fewer than 10,000) and time or costs are to be conserved, the original “father” disc might be used as the stamper in the mould rather than creating an entire “stamper family” consisting of a “father”, “mother” and “children” stampers.

The stamper is typically used in conjunction with an injection molder to produce replica discs. Commerically-available injection molding machines subject the mold to a large amount of pressure by piston-driven presses, in excess of 20,000 pounds.

In the disc moulding process, a resin is forced in through a sprue channel into a cavity within the optical tooling (mold) to form the optical disc substrate. Today most optical discs are made of optical-grade polycarbonate which is kept dry and clean to protect against reaction with moisture or other contaminants which may introduce birefringence and other problems into the disc, and which is injected into the mold in a molten state at a controlled temperature. The format of the grooves or pits are replicated in the substrate by the stamper as the cavity is filled and compressed against the stamper After the part has sufficiently cooled, the optical tooling mold is opened and the sprue and product eject are brought forward for ejecting the formed optical disc off of the stamper. The ejected disc substrate is handed out by a robot arm or gravity feed to the next station in the replication line, with transport time and distance between stations giving the disc substrate a chance to cool and harden.

The next step after molding in the manufacture of a read-only format is to apply a layer of reflective metal to the data-bearing side of the substrate (the side with the pits and lands). This is generally accomplished by a sputtering process, where the plastic disc is placed in a vacuum chamber with a metal target, and electrons are shot at the target, bouncing individual molecules of the metal onto the disc, which attracts and holds them by static electricity. The sputtered disc is then removed from the sputtering chanber and spin-coated with a polymer, typically a UV-curable lacquer, over the metal to protect the metal layer from wear and corrosion. Spin-coating occurs when the dispenser measures out a quantity of the polymer onto the disc in the spin-coating chamber and the disc is spun rapidly to disperse the polymer evenly over its entire surface.

After spin-coating, the lacquer (when lacquer is used as the coat) is cured by exposing it to UV radiation from a lamp, and the discs are visually inspected for reflectivity using a photodiode to ensure sufficient metal was deposited on the substrate in a sufficiently thick layer so as to permit every bit of data to be read accurately. Discs that fail the visual inspection are loaded onto a reject spindle and later discarded. Those that pass are generally taken to another station for labeling or packaging. Some of the “passed” discs may be spot-checked with other testing equipment for quality assurance purposes.

Optical discs have greatly reduced the manufacturing costs involved in selling content such as software, video and audio works, and games, due to their small size and the relatively inexpensive amount of resources involved in their production. They have also unfortunately improved the economics of the pirate, and in some media, such as video and audio, have permitted significantly better pirated-copies to be sold to the general public than permitted with other data storage media. Media distributors report the loss of billions of dollars of potential sales due to high quality copies.

Typically, a pirate makes an optical master disc by extracting logical data from the optical disc, copying it onto a magnetic tape, and setting the tape on a mastering apparatus. Pirates also sometimes use CD or DVD recordable disc duplicator equipment to make copies of a distributed disc, which duplicated copies can be sold directly or used as pre-masters for creating a new glass master for replication. Hundreds of thousands of pirated discs can be pressed from a single master disc with no degradation in the quality of the information stored on the discs. As consumer demand for optical discs remains high, and because such discs are easily reproduced at a low cost, counterfeiting has become prevalent.

A variety of copy protection techniques and devices have been proposed in the art to limit the unauthorized copying of optical media. Among these techniques are analog Colorstripe Protection System (CPS), CGMS, Content Scrambling System (CSS) and Digital Copy Protection System (DCPS). Analog CPS (also known as Macrovision) provides a method for protecting videotapes as well as DVDs. The implementation of Analog CPS, however, may require the installation of circuitry in every player used to read the media. Typically, when a disc or tape is “Macrovision Protected,” the electronic circuit sends a colorburst signal to the composite video and s-video outputs of the player resulting in imperfect copies. Unfortunately, the use of Macrovision may also adversely affect normal playback quality.

With CGMS the media may contain information dictating whether or not the contents of the media can be copied. The device that is being used to copy the media must be equipped to recognize the CGMS signal and also must respect the signal in order to prevent copying. The Content Scrambling System (CSS) provides an encryption technique to that is designed to prevent direct, bit-to-bit copying. Each disc player that incorporates CSS is provided with one of four hundred keys that allow the player to read the data on the media, but prevents the copying of the keys needed to decrypt the data. However, the CSS algorithm has been broken and has been disseminated over the Internet, allowing unscrupulous copyists to produce copies of encrypted discs.

The Digital Copy Protection System (DCPS) provides a method whereby devices that are capable of copying digital media may only copy discs that are marked as copyable. Thus, the disc itself may be designated as uncopyable. However, for the system to be useful, the copying device must include the software that respects that “no copy” designation.

While presently available copy protection techniques make it more difficult to copy data from optical media, such techniques have not been shown to be very effective in preventing large scale manufacture of counterfeit copies. The hardware changes necessary to effectuate many copy protection schemes simply have not been widely accepted. Nor have encryption code protection schemes been found to be fool proof in their reduction of the copying of optical disc data, as data encryption techniques are routinely cracked.

There is a need therefore for a copy-protected optical disc which does not depend entirely on encryption codes or special hardware to prevent the copying of the disc. Such optical discs should also be easily and economically manufactured given the current strictures of optical disc manufacture. The copy-protected discs should also be readable by the large number of existing disc readers or players without requiring modifications to those devices.

### Definitions

“Flourescent Compound”: a compound that radiates light in response to excitation by electromagnetic radiation. By “flourescent compound” it is meant to include, without limitation, phosphorescent compounds.

“Light-sensitive Material”: a material capable of being activated so as to change in a physically measurable manner, other than in opacity, upon exposure to one or more wavelengths of light. A light-sensitive material may be said to be reversible when the activated change becomes undetectable by the detector first detecting the change due to the passage of time or change in ambient conditions.

“Optical disc”: a medium of any geometric shape (not necessarily circular) that is capable of storing digital data that may be read by an optical reader.

“Reader”: any device capable of detecting data that has been recorded on an optical disc. By the term “reader” it is meant to include, without limitation, a player. Examples are CD and DVD readers.

“Read-only Optical Disc”: an optical disc that has digital data stored in a series of pits and lands.

“Registration Mark”: a physical and/or optical mark used to allow precise alignment between one substrate and another substrate such that when the registration marks are aligned, the corresponding positions on each substrate are known. For example, when two discs are juxtaposed against one another such that their registration marks are aligned, the point on one substrate corresponding to a physical and/or optical deformation on the other substrate is known.

“Re-read”: reading a portion of the data recorded on a medium after it has been initially read.

“Recording Layer”: a section of an optical disc where the data is recorded for reading, playing or uploading to a computer. Such data may include software programs, software data, audio files and video files.

“Temporary Material”: material that is detectable for a limited amount of time or a limited number of readings.

### SUMMARY OF THE INVENTION

The present invention provides an optical disc, and a method of manufacturer thereof, that provides copy protection by incorporating a light-sensitive compound in or on the optical disc at discrete positions (loci) such that it provides for altering of the digital data output from a section of the recording layer in a predictable manner. Such disc permits the data to be read without requiring alteration to the hardware, firmware or software used in optical media readers while preventing reproduction of the medium. The optical discs of the present invention provide producers and distributors of digital data with a data distribution medium that prevents reproducing of their digital data, for example, software, audio and video. The present invention particularly relates to read-only optical discs including, but not limited to CD, CD-ROM, DVD, DVD-5, DVD-9, DVD-10, DVD-18 and DVD-ROM, where optical deformations representing the data are introduced permanently into at least a portion of the optical disc prior to distribution to an end-user. As would be understood by one of ordinary skill in the art, however, the present invention may also be used with writable discs such as CD-R and DVD-R

As set forth in co-pending U.S. patent application Ser. No. 09/608,886, the present inventors have discovered a method for altering and/or augmenting the optically-read data stored on an optical disc in a manner that does not prevent the underlying data from being read by a conventional optical disc reader, but prevents the production of a useable optical disc copy using such readers. The present inventors have found that by selectively placing certain reversible light-sensitive materials, and in particular fluorescent materials, at discrete positions on a disc, that a conventional optical reader can be made at the first pass of such positions to read the data represented by the optical deformations correctly, but on a second pass read the data differently due to the activation of the reversible light-sensitive material. That is, the passing light of the reader may be used to influence the compound and change its properties so that upon re-reading, the signal that is received by the detector is different from that which was received upon initial sampling. For example, the light-sensitive compound may become reflective within a timeframe that provides for reflectance of the light beam upon resampling. Alternatively, the light-sensitive material may provide for delayed emission or absorbance of light, thereby altering the signal either positively or negatively. As most optical disc readers and players are pre-programmed to re-sample data areas of the recording layer to assure correct copying, such discs will fail to copy as a data string read from the recording layer will vary according to whether the light-sensitive material is activated upon sampling. That is, re-sampling of a data area in proximity to the light sensitive material may result in a different data read than when the data was initially read. Even if a copy can be made, that copy will be invalid if a program on the disc requires two different reads to access data on the disc. That is, the copy will be invalid since it will only represent one of two possible states at that data locus.

In one embodiment described in U.S. application Ser. No. 09/608,886, there is provided copy protection in that the optical disc itself has code that instructs the optical reader to re-sample a data area where a light-sensitive material is found (or where the light-sensitive material affects the read), and to fail to permit the access to the data if upon re-reading the data area, that data elicited is the same as upon initial sampling. In another embodiment, the light-sensitive compound must be located at a particular locus for the optical media in operate. For example, software may be included on the disc to direct the optical reader to alter its focal length such that the light-sensitive material in a plane different from the optical data is detected and access to the optical data permitted only if such light-sensitive material is detected. U.S. application Ser. No. 09/608,886, which is herein incorporated by reference in its entirety, sets forth a number of light-sensitive materials that can be used to effectuate such copy-protected optical discs.

The present invention provides for specific optical disc designs, and methods for manufacturing such designs, that incorporate light-sensitive materials in a manner that selectively changes the data read-out of the recording layer of an optical disc upon re-sampling of those portions of the recording layer in proximity to the light-sensitive material foci. In particular, there is provided optical disc designs that may be easily and economically produced without significantly altering the injection molding manufacturing process of read-only optical discs (as set forth above).

In a first embodiment of the present invention there is provided an optical disc having light-sensitive material selectively imprinted or placed on the non-impressed (i.e., non-stamped) side of the recording layer of an optical disc. Such disc comprises a first substrate having two major surfaces, a data track disposed along one major surface of the first substrate, and a light-sensitive compound disposed on the other major surface of the first substrate cooperating with the data track to alter the data upon excitation with a suitable light stimulus (e.g., a particular wavelength). Such disc further preferably comprises a second substrate, preferably of similar optical properties (preferably of the same material), affixedly attached to the surface of the substrate where the light-sensitive compound is disposed.

A first embodiment optical disc of the present invention may be produced by disposing the light-sensitive material onto the non-impressed side of the substrate after the substrate has been stamped and sufficiently cooled, and after the optical tooling mould is opened (but before the sprue and product eject are brought forward for ejecting the formed optical disc off of the stamper). As would be understood by one of ordinary skill in the art such manufacturing technique permits precise registration of the light-sensitive material with the data impressions on the other surface of the substrate. Preferably the light-sensitive material is covered by a second substrate of similar (or identical) optical properties to protect the light-sensitive material from its ambient environment. Such second substrate may be affixed to the first substrate either before or after the sputtering step used to cover the stamped surface of the first substrate. Either or both of the first and second substrates may be spin-coated with an adhesive agent prior to formation of such disc such that the layers may be affixedly attached. Alternatively, the light-sensitive material may be coated with a polymer, as by spin-coating. For example, an optically-pure lacquer may be used to coat the light-sensitive materials.

In a second embodiment of the present invention, there is provided an optical disc comprising a first substrate layer having a first major surface and a second major surface, said first major surface of said first substrate layer having light-sensitive material thereon, and either of said first or second major surface of said first substrate layer, or both, having a registration mark thereon; a second substrate layer having a first major surface and a second major surface, said first major surface of said second substrate layer having information pits thereon, and either of said first or second major surface of said second substrate, or both, having a registration mark thereon, said second major surface of said second substrate being disposed along said first major surface of said first substrate layer such that the registration marks of said first and second substrates are aligned; a metal reflector layer, said metal reflector layer being disposed along said first major surface of said second substrate layer; a first overcoat layer being disposed along said metal reflector layer, and optionally a second overcoat layer being disposed along said second major surface of said first substrate layer.

A second embodiment optical disc may be produced by obtaining a first substrate having a first major surface and a second major surface and a registration mark on either of said first or second major surface, or both; imprinting in discrete positions on said first major surface of said first substrate layer light-sensitive material; obtaining a second substrate having a first major surface and a second major surface, and a registration mark on either of said first or second major surface, or both, said first major surface of said second substrate layer having information pits thereon; disposing said second major surface of said second substrate along said first major surface of said first substrate such that the registration marks on said first and second substrate are aligned and affixing said second major surface of said second substrate to said first major surface of said first substrate; metalizing said first major surface of said second substrate layer having said information pits; disposing a first overcoat layer along said metalized surface; and optionally disposing a second overcoat layer along said second major surface of said first substrate layer. As would be understood by one of ordinary skill in the art, the registration marks need not be on the actual surface of a substrate, but need to be detectable. By “a surface having a detectable registration mark” it is meant that a registration mark is detectable therethrough or thereon.

In a third embodiment of the present invention, there is provided an optical disc comprising a substrate having material(s) capable of reacting with one another, or being activated, such that they form a light-sensitive material(s) upon exposure to a particular light source of defined energy, such material being coated on the non-impressed (i.e., non-stamped) side of the recording layer of an optical disc. Such disc comprises a first substrate, a data track disposed along one surface of the first substrate, and the material(s) capable of being activated to form a light-sensitive material(s) upon exposure to a particular light source (of defined energy) coated on the non-embossed surface of the first substrate. For example, a laser may catalyze crosslinking of certain inactive material(s) to form light sensitive compounds, such as a fluorescent material. In this embodiment, the coated material is activated in discrete areas using the appropriate light source (and energy) so as to form a light-sensitive material at discrete points which will cooperate by their positioning with respect to the data track to alter the data upon excitation with a suitable light stimulus (e.g., a particular wavelength). This selective activation of various portions of the first substrate to form a light-sensitive compound may be performed in a manner similar to that used to write data to a CD-R disc. Such disc further preferably comprises a second substrate, preferably of similar optical properties (preferably of the same material), affixedly attached to surface of the substrate where the formed light-sensitive compounds are disposed. In an alternative to such embodiment, the material coated on the non-embossed (i.e., non-stamped) side of the recording layer of an optical disc may be light-sensitive material that may be selectively deactivated using a laser of particular wavelength and strength. In such case selective activation in the appropriate data spots can be caused by deactivating those portions of the coat which one does not wish to have light-sensitive properties.

Yet in a fourth embodiment of the present invention, an optical disc having light-sensitive material is formed by selectively placing the light-sensitive material into a pit or onto a land of a standard optical disc using microinjection techniques, well known in the art, prior to the metalizing step.

And yet in a fifth embodiment of the present invention, an optical disc having a adhesive material comprising the light-sensitive material, said adhesive material being adhered to one or more layer or surfaces of the disc is disclosed. For example, light sensitive material may be placed in a label, or in a optically clear material on a layer or surface of the disc such that the light sensitive material is positioned in the manner desired.

### BRIEF DESCRIPTION OF THE DRAWINGS

The accompanying drawings, which are incorporated in and constitute part of the specification, illustrate presently preferred embodiments of the invention, and together with the general description given above and the detailed description of the preferred embodiments given below, serve to explain the principles of the invention.

FIG. 1 is a cross-sectional view of a conventional prior art optical storage disc of the type generally referred to as a read-only optical storage disc;

FIG. 2 is a cross-sectional view of an exemplary optical storage disc of the present invention;

FIG. 3 is a cross-sectional view of an another exemplary optical storage disc of the present invention;

FIG. 4 is a diagrammatic flow chart of a conventional prior art injection molding technique for manufacturing read-only optical discs;

FIG. 5 is a diagrammatic flow chart of a preferred method of the present invention for manufacturing read-only optical discs with minor modification to the conventional injection molding for manufacturing read-only optical discs of the type set forth in FIG. 2.

FIG. 6 is a diagrammatic flow chart of a preferred method of the present invention for manufacturing read-only optical discs with minor modification to the conventional injection molding for manufacturing read-only optical discs of the type set forth in FIG. 3.

### DETAILED DESCRIPTION OF THE INVENTION

The present invention overcomes many of the problems associated with. prior art optical disc copy-protection systems. The present invention provides optical discs that use certain innate physical properties of the optical disc composition to prevent efficient copying of the optical disc. The invention provides for the altering of digital data output during the reading of such optical discs in such a manner that data is allowed to be read while preventing reproduction of the medium. Such invention does not require alterations to the hardware, firmware or software used in conventional optical readers. The alteration of data-reads is accomplished by selectively placing light-sensitive compounds in the discs, such light-sensitive compounds preferably reacting upon excitation from the light used by a conventional optical reader. By selective placement of such light-sensitive materials, a conventional optical reader may read optically encoded data one way prior to activation of the light-sensitive material, and in another manner after activation, and yet in the first manner when the light sensitive materials are no longer activated.

As would be understood by one of ordinary skill in the art, it is preferred that the light-sensitive material is selectively placed in register with the data pits and lands and the checksums set on the optical disc take into account the changeable data strings such that the Cross-Interleave Reed-Solomon Code (“CIRC”) decoder (standard on all CD players/readers) does not detect a read error preventing the underlying data from being read. Up to three percent of demodulated incoming frames from the reading laser can be corrected by an enhanced CIRC decoder. Both the data represented by the pits and lands, and the data represented by the light-sensitive material may need to be decoded to correct data strings by the CIRC decoder.

The present invention may be used with conventional optical media such as CDs and DVDs. The invention may also be incorporated into mass production techniques that are currently used to produce “read-only” CDs and DVDs, and hybrid read-only/recordable or rewritable data forms, and other physical disc formats, with minimal changes in the production equipment and line. As would be understood by one of ordinary skill in the art, the present invention may also be employed with recordable or rewritable data forms, albeit, more changes in the production equipment may be required.

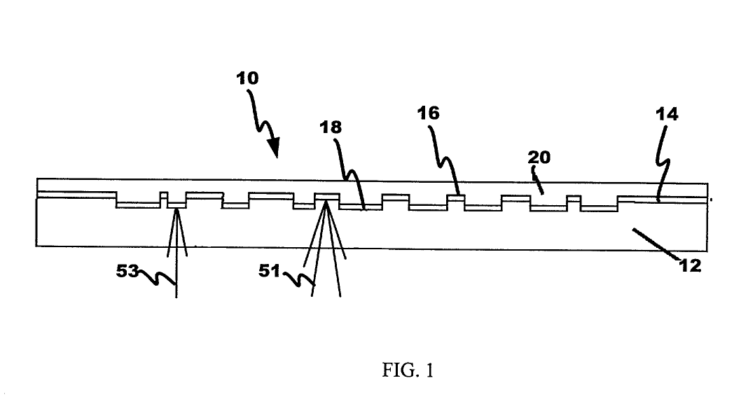

Now turning to the figures, there is shown in FIG. 1 a cross-sectional view of a prior art read-only optical storage disc 10 for storing pre-recorded data in a manner that can be read by a radiation beam interacting with the disc. A transparent polycarbonate substrate layer 12, or similar material having an optical transmission characteristic which permits the radiation interacting with the recording layer to be transmitted therethrough. A aluminum reflector layer 14 is found adjacent to polycarbonate substrate layer 12. Polycarbonate layer 12 is fabricated with the data stored as surface structure, illustrated as lands 16 and pits 18. Aluminum reflector layer 14 is disposed in such a manner as to provide a surface generally retaining the structure of the polycarbonate surface. A protective overcoat layer 20 is applied to aluminum reflector layer 14 in an uncured state and is cured by ultraviolet radiation. Also shown in FIG. 1 is the laser beam interaction with a position on a pit (51), and the laser beam interaction at a land (53).

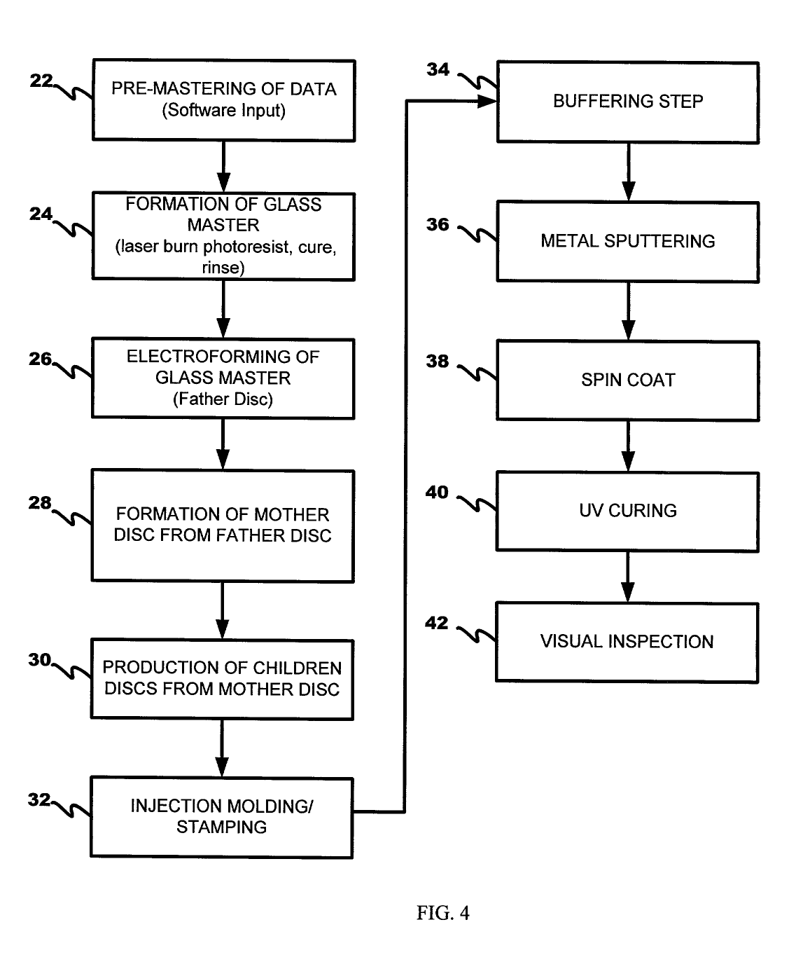

FIG. 4 is a diagrammatic flow chart of a conventional prior art injection molding technique for manufacturing read-only optical discs. Manufacture of an optical disc begins with premastering 22 (formatting) of the data. The premastered data is used to control a laser used in the glass mastering step 24 to remove photoresist material from a photoresist coated glass plate. The photoresist material is burnt by the laser, the photoresist is cured and unexposed photoresist rinsed off, and the resulting data-bearing glass master is then electroformed with a metal such as Ag or Ni (step 26) to form a father disc. The father disc may be used as a template to make a mirror image disc, known in the art as the mother disc (step 28). Mother disc is used to make optical duplicates of the father disc (step 30), such discs being referred to as children discs. Children discs are referred to as stampers when used to produce multiple discs in an injection moulder. If an entire disc “family” is not created, the father disc may be used directly as the stamper.

The injection moulding step 32 uses a stamper to form deformations in the manufactured discs representative of the premastered data of premastering step 22. The manufactured discs are then removed from the mould and allowed a cool down period, known in the art as the buffering step 34. The surface of the polycarbonate substrate carrying the deformations is coated with metal in metal sputtering step 36. In metal sputtering step 36 metal is coated over and within the deformations to form a metal layer over the polycarbonate substrate. Both the metal layer and the non-metalized polycarbonate substrate surfaces are coated with a protective polymer, typically lacquer, in spincoat step 38. The spincoated layers are then cured at UV curing step 40. The optical discs are then inspected at visual inspection step 42 and the optical discs are approved or rejected.

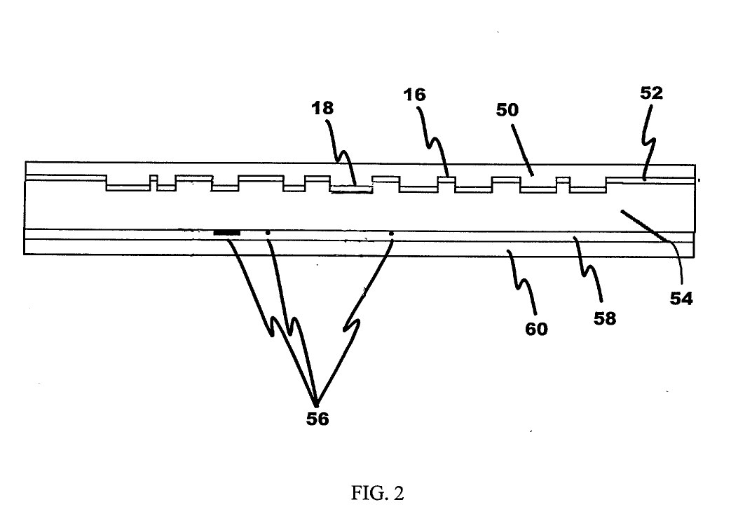

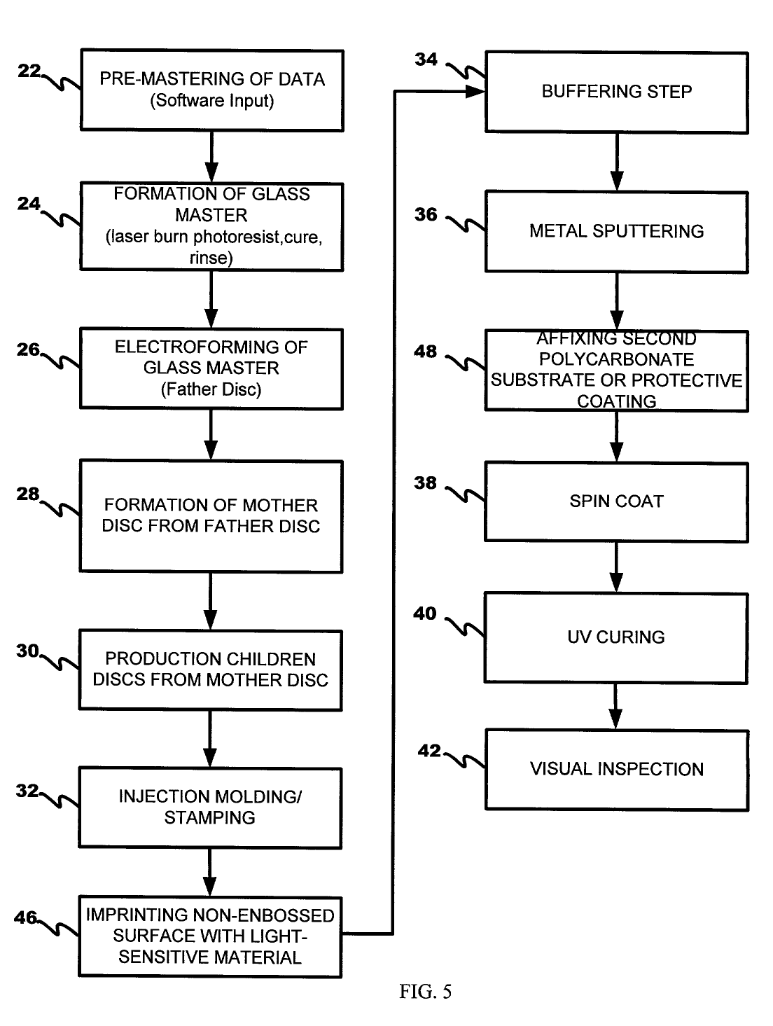

FIG. 5 is a diagrammatic flow chart of a preferred method of the present invention for manufacturing read-only optical discs with minor modification to the conventional injection moulding for manufacturing read-only optical discs of the type set forth in FIG. 2. As seen in the flow chart, additional steps 46 and 48 are added to the conventional method set forth in FIG. 4. Light-sensitive material is imprinted at step 46 on the surface of the mold which is not impressed with the child disc (i.e., the stamper) while the stamper is still in contact with the molding material, after the molding material has sufficiently cooled so as not to damage the light-sensitive properties of the material, and before the molded substrate is removed from the moulding apparatus. Imprinting may be done, for example, using gravure, laser printing, mylar screen printing, drop-on-demand printing, CIJ or other methods known in the art for imprinting materials. The resulting disc is treated as set forth above in FIG. 4, with the additional step 48 of adding a second polycarbonate substrate or protective layer over the surface imprinted with the light-sensitive material to protect such material for the ambient environment. FIG. 2 is a cross-sectional view of an exemplary optical storage disc manufactured by such technique comprising spin coat layers 50, metalized layer 52, impressed polycarbonate layer 54, light-sensitive material 56, bonding material layer 58, second polycarbonate layer 60.

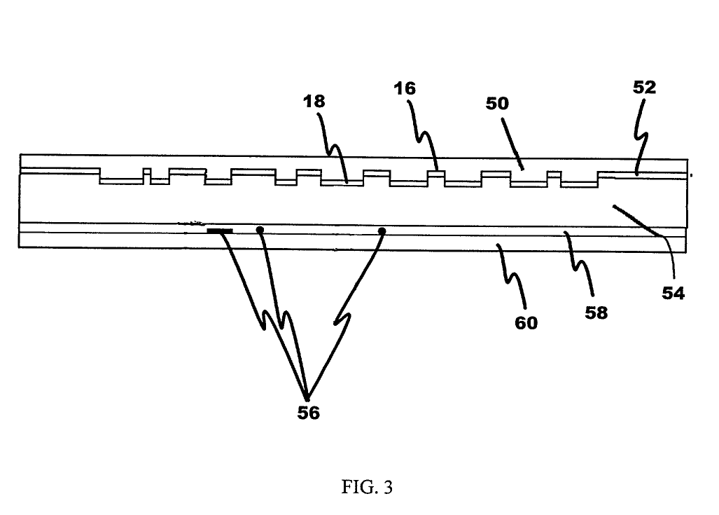

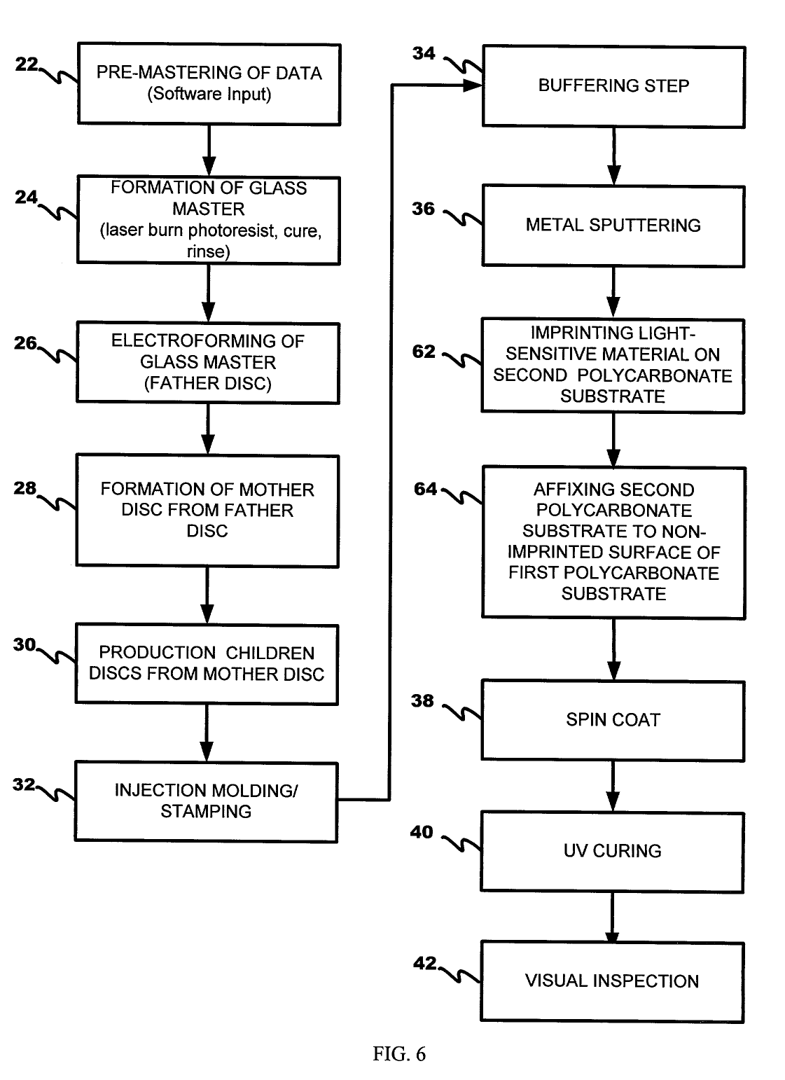

Now turning to FIG. 6 is a diagrammatic flow chart of a preferred method of the present invention for manufacturing read-only optical discs with minor modification to the conventional injection molding for manufacturing read-only optical discs of the type set forth in FIG. 3. The flow chart of FIG. 6 differs from that of the conventional technique for manufacturing read-only optical discs of FIG. 4, in including step 62 wherein light sensitive material is printed onto a second polycarbonate material. As would be apparent to one of ordinary skill in the art, step 62 can be concurrent with, prior to, or after the injection molding of the first substrate. Second polycarbonate substrate is affixed to the metalized polycarbonate disc having the information pits at step 64, which also may be performed other stages in the technique as would be understood by one of ordinary skill in the art. For example, the first substrate may be metal sputtered at the same time that the light-sensitive material is being imprinted on the second substrate. Attachment of the second polycarbonate substrate may be means of a hot melt or by way of bonding materials. FIG. 3 is a cross-sectional view of an exemplary optical storage disc manufactured by such technique comprising spin coat layers 50, metalized layer 52, impressed polycarbonate layer 54, light-sensitive material 56, bonding material layer 58, second polycarbonate layer 60.

While the invention has been described with respect to preferred embodiments, those skilled in the art will readily appreciate that various changes and/or modifications can be made to the invention without departing from the spirit or scope of the invention as defined by the appended claims. All documents cited herein are incorporated in their entirety herein.

What IS CLAIMED IS:

1. A method for fabricating an optical disc, said method comprising the steps of:
molding a substrate so as to have a first major surface with information pits thereon and a second major surface that is relatively planar;
placing light-sensitive material on or within said second major surface;
sealing said second major surface having said light sensitive material with a protective material so as to protect said light sensitive material from the ambient environment;
metalizing said first major surface;
sealing said metalized first major surface so as to protect said metal from the ambient environment.

2. The method of claim 1 wherein said substrate comprises polycarbonate.

3. The method of claim 1 wherein the light-sensitive material is a fluorescent compound.

4. The method of claim 1 wherein the light-sensitive material comprises a cyanine compound.

5. The method of claim 1 wherein the light-sensitive material is exitable by a light source emitting light at a wavelength between about 770 nm to about 830 nm.

6. The method of claim 1 wherein the light-sensitive materialis excitable by a light source emitting at a wavelength between about 630 nm to about 650 nm.

7. The method of claim 1 wherein the light-sensitive material is adapted to emit at 780 nm.

8. The method of claim 1 wherein the light-sensitive material is adapted to emit at 530 nm.

9. The method of claim 1 wherein the light-sensitive material excitable by a light source emitting light at a wavelength about 780 nm and a light source emitting at a wavelength about 530 nm.

10. The method of claim 1 wherein the light-sensitive material is on said second major surface of said substrate at distinct loci.

11. The method of claim 1 wherein the light-sensitive material is diffusively placed on said second major surface of said substrate by spin coating.

12. A method for fabricating an optical disc, said method comprising the steps of:
obtaining a first substrate having a first major surface and a second major surface;
placing light-sensitive material on or within one or both major surfaces of said first substrate;
obtaining a second substrate having a first and a second major surface, said first major surface having information pits thereon;
affixing said first substrate having said light-sensitive material to said second substrate to said second major surface of said second substrate.

13. The method of claim 12 wherein said first substrate comprises polycarbonate.

14. The method of claim 12 wherein said second substrate comprises polycarbonate.

15. The method of claim 12 wherein the light-sensitive material is a fluorescent compound.

16. The method of claim 12 wherein the light-sensitive material comprises a cyanine compound.

17. The method of claim 12 wherein the light-sensitive material is excitable by a light source emitting light at a wavelength between about 770 nm to about 830 nm.

18. The method of claim 12 wherein the light-sensitive materialis excitable by a light source emitting at a wavelength between about 630 nm to about 650 nm.

19. The method of claim 12 wherein the light-sensitive material is adapted to emit at 780 nm.

20. The method of claim 12 wherein the light-sensitive material is adapted to emit at 530 nm.

21. The method of claim 12 wherein the light-sensitive material excitable by a light source emitting light at a wavelength about 780 nm and a light source emitting at a wavelength about 530 nm.

22. The method of claim 12 wherein the light-sensitive material is placed at distinct loci.

23. The method of claim 12 wherein the light-sensitive material is diffusively applied by spin coating.

24. A method for fabricating an optical disc, said method comprising the steps of:
obtaining a first substrate having a first major surface and a second major surface, said first or second major surface, or both, having a detectable registration mark;
imprinting in select areas said first major surface of said first substrate layer with light-sensitive material;
obtaining a second substrate having a first major surface and a second major surface, said first major surface of said second
substrate layer having information pits thereon and either of said first or second major surface, or both, having a detectable registration mark;
affixing said second major surface of said second substrate along said first major surface of said first substrate so as said detectable registration marks overlap each other;
metalizing said first major surface of said second substrate layer having said information pits;
disposing a first overcoat layer along said metalized surface; and
optionally disposing a second overcoat layer along said second major surface of said first substrate layer.

25. The method of claim 24 wherein said first substrate comprises polycarbonate.

26. The method of claim 24 wherein said second substrate comprises polycarbonate.

27. The method of claim 24 wherein the light-sensitive material is a fluorescent compound.

28. The method of claim 24 wherein the light-sensitive material comprises a cyanine compound.

29. The method of claim 24 wherein the light-sensitive material is exitable by a light source emitting light at a wavelength between about 770 nm to about 830 nm.

30. The method of claim 24 wherein the light-sensitive materialis excitable by a light source emitting at a wavelength between about 630 nm to about 650 nm.

31. The method of claim 24 wherein the light-sensitive material is adapted to emit at 780 nm.

32. The method of claim 24 wherein the light-sensitive material is adapted to emit at 530 nm.

33. The method of claim 24 wherein the light-sensitive material excitable by a light source emitting light at a wavelength about 780 nm and a light source emitting at a wavelength about 530 nm.

34. The method of claim 24 wherein the light-sensitive material is placed at distinct loci.

35. The method of claim 24 wherein the light-sensitive material is diffusively applied by spin coating.

36. An optical disc comprising:
a first substrate layer having a first major surface and a second major surface, said first major surface of said first substrate layer having light-sensitive material thereon;
a second substrate layer having a first major surface and a second major surface, said first major surface of said second substrate layer having information pits thereon, and said second major surface being disposed along said first major surface of said first substrate layer;
a metal reflector layer said metal reflector layer being disposed along said first major surface of said second substrate layer;
a first overcoat layer being disposed along said metal reflector layer; and
optionally a second overcoat layer being disposed along said second major surface of said first substrate layer.
